(19) United States
(12) Patent Application Publication
(10) Pub. No.: US 2019/0025123 A1
(43) Pub. Date: Jan. 24, 2019

(54) SPECTRAL DATA PROCESSING APPARATUS AND SPECTRAL DATA PROCESSING METHOD

(71) Applicant: HITACHI HIGH-TECH SCIENCE CORPORATION, Tokyo (JP)

(72) Inventor: Masahiro SAKUTA, Tokyo (JP)

(21) Appl. No.: 16/041,670

(22) Filed: Jul. 20, 2018

(30) Foreign Application Priority Data
Jul. 21, 2017 (JP) 2017-142237

(51) Int. Cl. G01J 3/30; G01N 30/86; G01J 3/46; G09G 3/20; G09G 5/10

(52) U.S. Cl. CPC G01J 3/30; G01N 30/8644; G09G 5/10; G09G 3/2003; G01J 3/46

(57) ABSTRACT

A spectral data processing apparatus where a particular spectrum is displayed on a display based on 3D spectral data having time, signal intensities, and a prescribed parameter, comprising: a 2D spectrum calculating unit compiling the signal intensities for each point in time and calculating 2D spectrum of the signal intensities and the prescribed parameter, based on the spectral data; a signal-intensity-time change calculating unit calculating change in signal intensity over time for each value of the prescribed parameter, based on the spectral data; and a display controlling unit displaying, on the display, the 2D spectrum and the change in the signal intensity over time in superimposed manner using multicolor, light and shading, or change in brightness, so that the change in signal intensity over time is displayed to match the prescribed parameter of the 2D spectrum and the time changes along the axis of signal intensities of the 2D spectrum.

### CROSS REFERENCE TO RELATED APPLICATION(S)

This application claims priority and the benefit of Japan Patent Application No. JP 2017-142237, by SAKUTA, filed Jul. 21, 2017, which is hereby incorporated by reference in its entirety into this application.

### BACKGROUND OF THE INVENTION

### 1. Technical Field

The present invention relates to a spectral data processing apparatus and a spectral data processing method.

### 2. Description of the Related Art

With respect to a mass spectrometry, an analysis such as identification of a substance is performed using a mass spectrum. The mass spectrum is a two dimensional spectrum in which a horizontal axis represents a mass-to-charge ratio (m/z) and a vertical axis represents signal intensity.

In LC/MS spectrometry or GC/MS spectrometry, a technology has been developed in which various analysis results such as a chromatogram and a mass spectrum are obtained, and these analysis results are displayed in association with each other to allow visualization thereof to be realized (Patent Document 1).

### DOCUMENTS OF RELATED ART

(Patent document 1) Japan Patent Application Publication No. 2014-219317

### SUMMARY OF THE INVENTION

A thermal desorption ionization mass spectrometer ionizes a gas component evolved by heating a sample, thereby performing mass spectrometry. Herein, the timing of thermal desorption of the gas component contained in the sample is different depending on molecular species or heating conditions, and there is a possibility that information of components actually contained in the sample can be read from a change in the mass spectrum over time. For example, when different peaks of a mass-to-charge ratio occur at the same time, these peaks are likely to be fragments derived from the same material. In addition, it is highly likely that components that are always detected regardless of change in heating temperature over time are impurities (contamination) or noise.

However, considering the characteristics of a chromatogram (total ion chromatogram; compiling signal intensities for each mass-to-charge ratio and showing a change in signal intensity over time) or a mass spectrum, analysis and visual recognition thereof are difficult to achieve.

For example, as shown in FIG. 15, it is possible in principle that mass spectra M1 to M3 for each point of time are superimposed on the same screen and a change in a peak A over time is analyzed (the peak A is extinguished in the mass spectrum M2 over time in FIG. 15).

However, when the number of peaks in the mass spectrum is large, it is difficult to superimpose the mass spectra for each point of time on the same screen, and it is also difficult to display the mass spectra every short time interval in a limited screen space. For this reason, it is difficult to easily and carefully analyze a change in time of the mass spectrum in two dimensions.

The present invention has been made to solve the above problems and it is an object of the present invention to provide an apparatus for processing spectra data and a method of processing spectra data, to allow a relationship between time, signal intensity, and a prescribed parameter of three dimensional spectral data, to be easily understood visually in two dimensions.

In order to achieve the above object, a spectral data processing apparatus according to the present invention, in which a particular spectrum is displayed on a display on a basis of three dimensional spectral data having time, signal intensities, and a prescribed parameter, includes a two dimensional spectrum calculating unit compiling the signal intensities for each point of the time and calculating a two dimensional spectrum of the signal intensities and the prescribed parameter, on a basis of the spectral data; a signal intensity-time change calculating unit calculating a change in the signal intensity over time for each value of the prescribed parameter, on a basis of the spectral data; and a display controlling unit displaying the two dimensional spectrum on the display, and displaying the change in the signal intensity over time in a superimposed manner on the display using multicolor, light and shading, or a change in brightness, in such a way that the prescribed parameter of the two dimensional spectrum are consistent and an axis of the signal intensities of the two dimensional spectrum represents the time.

According to the spectral data processing apparatus, since the change in signal intensity over time is two-dimensionally displayed in a superimposed manner, in such a way that the parameter of the two dimensional spectrum is consistent, a relationship between time, signal intensity, and parameter of the three dimensional spectral data may be easily understood visually in detail in two dimensions.

In the spectral data processing apparatus of the present invention, the spectral data may be mass spectrometry data, the parameter may be a mass-to-charge ratio, and the two dimensional spectrum may be a mass spectrum.

In the spectral data processing apparatus of the present invention, the spectral data may be mass spectrometry data of an organic compound.

In the spectral data processing apparatus of the present invention, the spectral data may include fragmentation ions generated from the organic compound.

In the spectral data processing apparatus of the present invention, the display controlling unit may be configured to display the two dimensional spectrum and the signal intensities on the display in a superimposed manner, and display a chromatogram representing a relationship between time and signal intensity on the display in a superimposed manner.

A spectral data processing method according to the present invention, in which a particular spectrum is displayed on a display on a basis of three dimensional spectral data having time, signal intensities, and a prescribed parameter, includes: a two dimensional spectrum calculating step compiling the signal intensities for each point of the time and calculating a two dimensional spectrum of the signal intensities and the prescribed parameter, on a basis of the spectral data; a signal intensity-time change calculating step calculating a change in the signal intensity over time for each value of the prescribed parameter, on a basis of the spectral data; and a display controlling step displaying the two dimensional spectrum on the display, and displaying the change in the signal intensity over time in a superimposed manner on the display using multicolor, light and shading, or a change in brightness, in such a way that the prescribed parameter of the two dimensional spectrum are consistent and an axis of the signal intensities of the two dimensional spectrum represents the time.

According to the present invention, a relationship between time, signal intensity, and parameter of three dimensional spectral data can be easily understood visually in detail in two dimensions.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a perspective view showing a configuration of an evolved gas analysis apparatus including a mass spectrometer according to an embodiment of the present invention;

FIG. 2 is a perspective view showing a configuration of a gas evolving unit;

FIG. 3 is a vertical sectional view showing a configuration of the gas evolving unit;

FIG. 4 is a transverse cross-sectional view showing a configuration of the gas evolving unit;

FIG. 5 is a partially enlarged view of FIG. 4;

FIG. 6 is a block diagram showing an operation of analyzing a gas component using an evolved gas analysis apparatus;

FIG. 7 is a diagram showing an example of a mass spectrum calculated by the two dimensional spectrum calculating unit;

FIG. 8 is a schematic diagram showing a change in signal intensity over time calculated by a signal intensity-time change-calculating unit;

FIG. 9 is a diagram displaying a change in signal intensity over time in a superimposed manner on the mass spectrum of FIG. 7;

FIG. 10 is a schematic diagram of a conventional mass spectrum in which two peaks F are observed;

FIG. 11 is a schematic diagram in which a change in signal intensity over time is displayed in a superimposed manner on a mass spectrum of FIG. 10;

FIG. 12 is a partially enlarged view of a vertical axis of FIG. 9;

FIG. 13 is a diagram in which a change in signal intensity over time and a chromatogram are displayed in a superimposed manner on a mass spectrum;

FIG. 14 is another diagram in which a change in signal intensity over time and a chromatogram are displayed in a superimposed manner on a mass spectrum; and

FIG. 15 is a conventional diagram in which mass spectra for each point of time is time-sequentially displayed on the same screen.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated to make the description clearer.

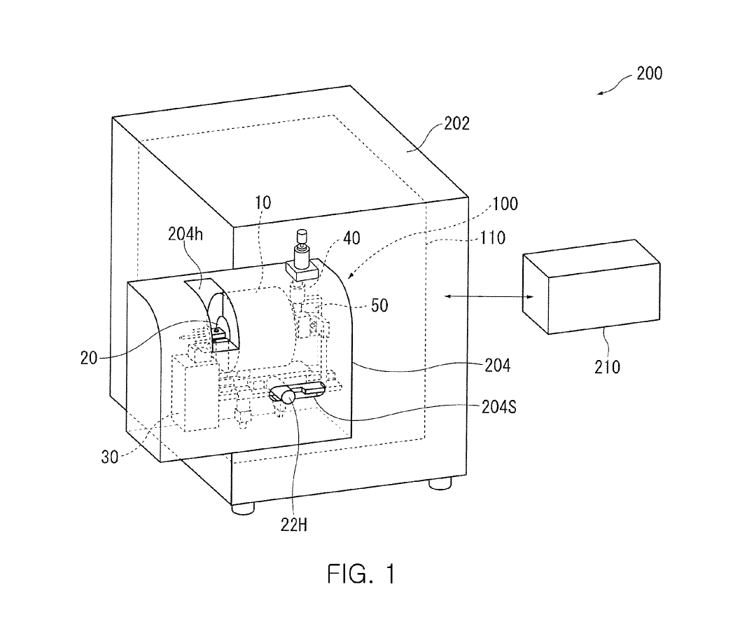

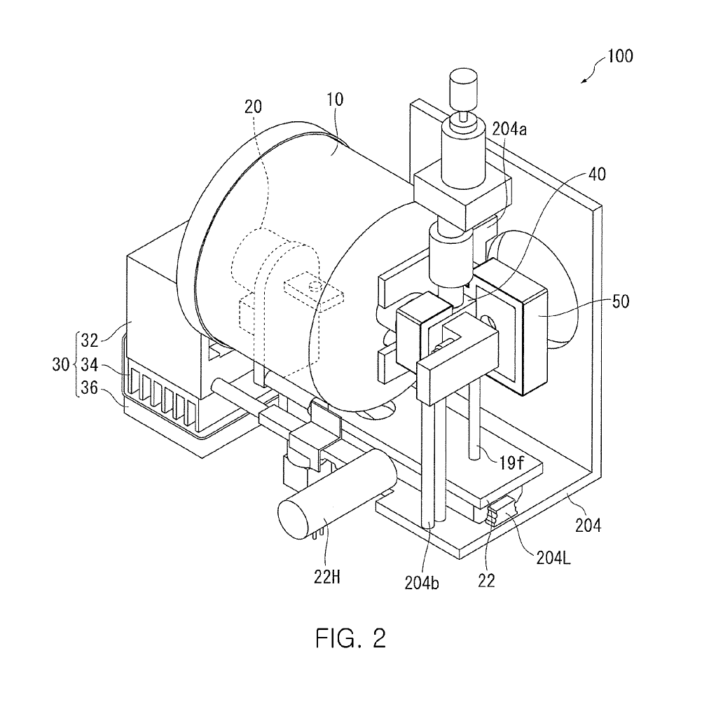

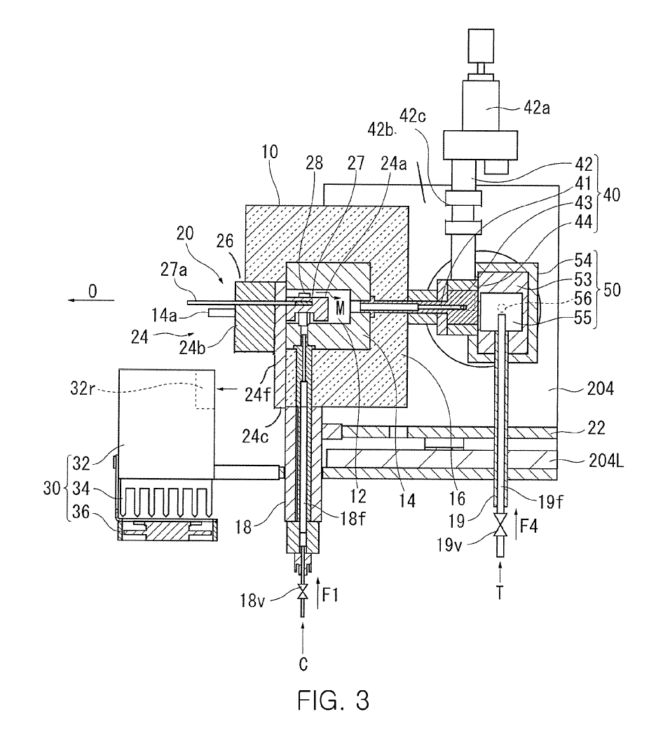

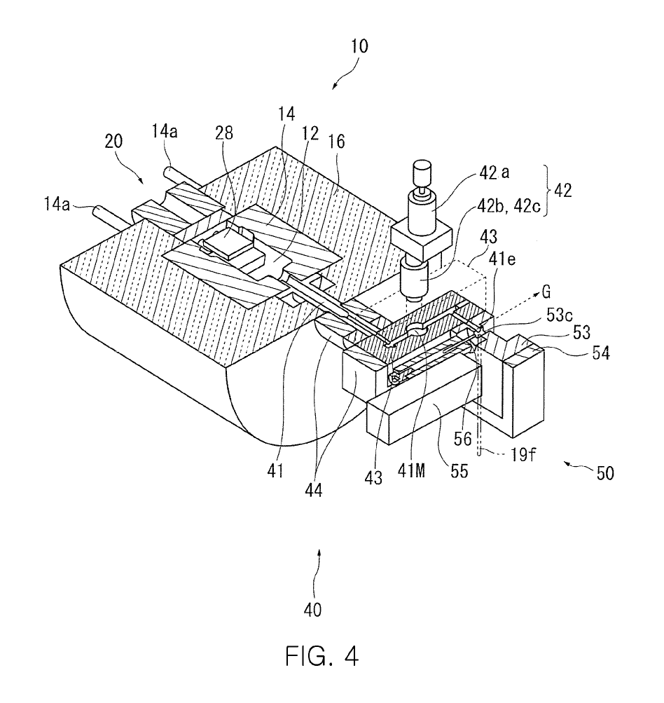

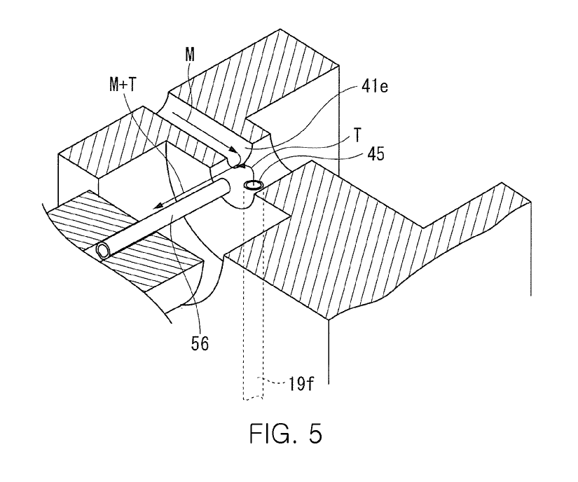

Hereinafter, embodiments of the present invention will be described with reference to the drawings. FIG. 1 is a perspective view showing the configuration of an evolved gas analysis apparatus 200 including a mass spectrometer (mass analysis apparatus) 110 according to an embodiment of the present invention, FIG. 2 is a perspective view showing the configuration of a gas evolving unit 100, FIG. 3 is a vertical sectional view showing the configuration of the gas evolving unit 100 FIG. 4 is a transverse cross-sectional view showing the configuration of the gas evolving unit 100 along a central axis O, and FIG. 5 is a partially enlarged view of FIG. 4.

The evolved-gas analysis apparatus 200 includes a body unit 202 that is a housing, an attaching unit 204 for a gas evolving unit, the attaching unit having a box shape and attached at a front of the body unit 202, and a computer (controlling unit) 210 for control thereof. The computer 210 has a CPU for performing data processing, a storage 215 for storing computer programs or data, a display 220 such as a liquid crystal monitor, an input unit such as a keyboard, and the like.

In the attaching unit 204 for the gas evolving unit, there are a heating furnace 10 having a cylinder shape, a sample holder 20, a cooling unit 30, a splitter 40 splitting gas, an ion source 50, and an inert gas flow passage 19f as a gas evolving unit 100 of a single assembly. In addition, in the body unit 202, a mass spectrometer 110 for analyzing a gas component evolved by heating a sample is received.

As shown in FIG. 1, an opening 204h is provided at an upper surface of the attaching unit 204 for the gas evolving unit, while being provided at a front surface thereof. The sample holder 20 is located at the opening 204h by being moved toward a discharge position (described later) that is located at an outside of the heating furnace 10. Therefore, a sample may be supplied on or removed from the sample holder 20 through the opening 204h. In addition, a slit 204s is provided at the front surface of the attaching unit 204. By moving an opening/closing handle 22H exposed to an outside of the attaching unit through the slit, the sample holder 20 is moved into and from the heating furnace 10. Therefore, the sample holder is set at the discharging position, and thus the sample is supplied on or removed from the sample holder.

In addition, for example, when the sample holder 20 is moved on a movement rail 204L (described later) by a stepping motor, etc. controlled by the computer 210, the sample holder 20 may be automatically moved into or from the heating furnace 10.

Hereinafter, referring to FIGS. 2 to 6, the configuration of the gas evolving unit 100 will be described.

First, the heating furnace 10 is attached to an attaching plate 204a of the attaching unit 204 by being parallel to the axis O. The heating furnace includes a heating chamber 12 having a cylinder shape and being opened on the axis O; a heating block 14; and a heat retaining jacket 16.

The heating block 14 surrounds the heating chamber 12, and the heat retaining jacket 16 surrounds the heating block 14. The heating block 14 is made of aluminum, and is heated by electricity from a pair of heater electrodes 14a (see FIG. 4) extending from the heating furnace 10 to outside in a direction of the axis O as shown in FIG. 4.

In addition, the attaching plate 204a extends in a direction perpendicular to the axis O. The splitter 40 and the ion source 50 are attached to the heating furnace 10. In addition, a supporter 204b extends in a vertical direction of the attaching unit 204, and the ion source 50 is supported by the supporter 204b.

The splitter 40 is connected to an opposite side (right side in FIG. 3) of an opening side of the heating furnace 10. In addition, a carrier gas protecting pipe 18 is connected to a lower side of the heating furnace 10. In the carrier gas protecting pipe 18, a carrier gas channel 18f that communicates with a lower surface of the heating chamber 12 to introduce carrier gas C into the heating chamber 12 is provided. A valve 18v is located in the carrier gas channel 18f to adjust a flow rate F1 of the carrier gas C.

In addition, a mixed gas channel 41 communicates with a cross section on the opposite side (the right side in FIG. 3) of an opening side of the heating chamber 12. Mixed gas M of the carrier gas C and gas component G evolved by the heating furnace 10 (heating chamber 12) flows through the mixed gas channel 41.

Meanwhile, as shown in FIG. 3, an inert gas protecting pipe 19 is connected to the lower side of the ion source 50 and an inert gas channel 19f is provided in the inert gas protecting pipe 19 to allow an inert gas T to be introduced into the ion source 50. Further, a valve 19v is located in the inert gas channel 19f to adjust a flow rate F4 of the inert gas T.

The sample holder 20 includes a stage 22 that moves on the movement rail 204L attached to an inner upper surface of the attaching unit 204; a bracket 24c attached on the stage 22 and extending in a vertical direction; insulators 24b and 26 attached to a front surface of the bracket 24c; a sample holding unit 24a extending from the bracket 24c in a direction of the axis O in the heating chamber 12; a sample heater 27 provided just below the sample holding unit 24a, and a sample plate 28 provided on an upper surface of the sample holding unit 24a above the heater 27, wherein the sample is placed on the sample plate.

Herein, the movement rail 204L extends in a direction of the axis O (horizontal direction of FIG. 3), and the stage 22 of the sample holder 20 moves in the direction of the axis O. In addition, the opening/closing handle 22H extends in a direction perpendicular to the direction of the axis O and is attached to the stage 22.

In addition, the bracket 24c has a long rectangular shape having a semicircular upper portion. Referring, to FIG. 3, the insulator 24b has a substantially cylinder shape, and is provided at a front surface of an upper portion of the bracket 24c. An electrode 27a of the sample heater 27 penetrates the insulator 24b, and protrudes to an outside of the gas evolving unit. The insulator 26 has a rectangular shape, and is provided at the front surface of the bracket 24c. The insulator 26 is located lower than the insulator 24b. In addition, the insulator 26 is not provided at a lower portion of the bracket 24c, and a front surface of the lower portion of the bracket 24 c is exposed to form a contact surface 24f.

The bracket 24c has a diameter slightly larger than a diameter of the heating chamber 12 such that the bracket 24c seals the heating chamber 12. The sample holding unit 24a is located in the heating chamber 12.

In addition, the sample placed on the sample plate 28 in the heating chamber 12 is heated in the heating furnace 10 such that the gas component G is evolved.

The cooling unit 30 faces the bracket 24c of the sample holder 20, and is located at an outside of the heating furnace 10 (left side of the heating furnace 10 in FIG. 3). The cooling unit 30 includes a cooling block 32 having a recessed portion 32 r that has a rectangular shape; cooling fins 34 connected to a lower surface of the cooling block 32; and a pneumatic cooling fan 36 connected to a lower surface of the cooling fins 34, and blowing air to the cooling fins 34.

In addition, when the sample holder 20 moves in a direction of the axis O on the movement rail 204L toward a left side of FIG. 3, and comes out of the heating furnace 10, the contact surface 24f of the bracket 24c is positioned at the recessed portion 32r of the cooling block 32 by being in contact with the recessed portion. Consequently, as heat of the bracket 24c is removed by the cooling block 32, the sample holder 20 (particularly, the sample holding unit 24 a) is cooled.

As shown in FIGS. 3 and 4, the splitter 40 includes the mixed gas channel 41 connected to the heating chamber 12; a branching channel 42 connected to the mixed gas channel 41, and opened to the outside; a back pressure controller 42a connected to a discharge side of the branching channel 42 to control a back pressure of the mixed gas M discharged through the branching channel 42; a housing unit 43 having an end of the mixed gas channel 41 inside thereof; and a heat retaining unit 44 surrounding the housing unit 43.

In this embodiment, a filter 42b is provided between the branching channel 42 and the back pressure controller 42a to remove impurities from the mixed gas. Without mounting a valve for regulating the back pressure such as the mass flow controller 42a or the like, the branching channel 42 may be a pipe with an exposed end.

As shown in FIG. 4, when viewed from the top, the mixed gas channel 41 is connected to the heating chamber 12 and extends in a direction of the axis O and next, bends in a direction perpendicular to the axis O, and bends again in a direction of the axis O such that the gas channel reaches an end part 41e. The gas channel has a crank shape. In addition, a portion of the mixed gas channel 41 that extends in a direction perpendicular to the axis O is provided with a center thereof having an enlarged diameter to define a branch chamber 41M. The branch chamber 41M extends to an upper surface of the housing unit 43. The branch chamber 41M is fitted with the branching channel 42 having a diameter slightly smaller than that of the branch chamber 41M.

The mixed gas channel 41 may have a straight line shape extending in a direction of axis O from the heating chamber 12 connected with the gas channel to the end part 41e. Alternatively, depending on a positional relationship with the heating chamber 12 or with the ion source 50, the mixed gas channel 41 may have a variously curved shape, a line shape having an angle to the axis O, etc.

As shown in FIGS. 3 and 4, the ion source 50 includes a ionizer housing unit 53; an ionizer heat retaining unit 54 surrounding the ionizer housing unit 53; a discharge needle 56; and a staying unit 55 fixing the discharge needle 56. The ionizer housing unit 53 has a plate shape, and a surface of the plate is parallel to the axis O. A small hole 53C penetrates the center of the surface of the plate. In addition, the end part 41e of the mixed gas channel 41 passes through the ionizer housing unit 53, and faces a side wall of the small hole 53C. In the meantime, the discharge needle 56 extends in a direction perpendicular to the axis O, and faces the small hole 53C.

As shown in FIGS. 4 and 5, the inert gas flow passage 19f passes through the ionizer housing unit 53 vertically and the tip end of the inert gas flow passage 19f faces a lower surface f the small hole 53c of the ionizer housing unit 53 to form a merging portion 45 joining the end part 41e of the mixed gas channel 41.

In addition, the inert gas T from the inert gas flow passage 19f is mixed with the mixed gas M introduced into the merging portion 45 near the small hole 53c from the end part 41e, so that the resulting gas M+T flows into the discharge needle 56 and the gas component G of the resulting gas M+T is ionized by the discharge needle 56.

The ion source 50 is a well-known device. According to the exemplary embodiment of the present invention, atmospheric pressure chemical ionization (APCI) is applied to the ion source. APCI causes minimal fragmentation of the gas component G, such that a fragmentation peak does not occur. Therefore, it is possible to detect the measurement target without separating the gas component G by using a chromatograph, etc.

The gas component G ionized at the ion source 50, the carrier gas C and the inert gas T are introduced to the mass spectrometer 110, and are analyzed.

In addition, the ion source 50 is contained in the ionizer heat retaining unit 54.

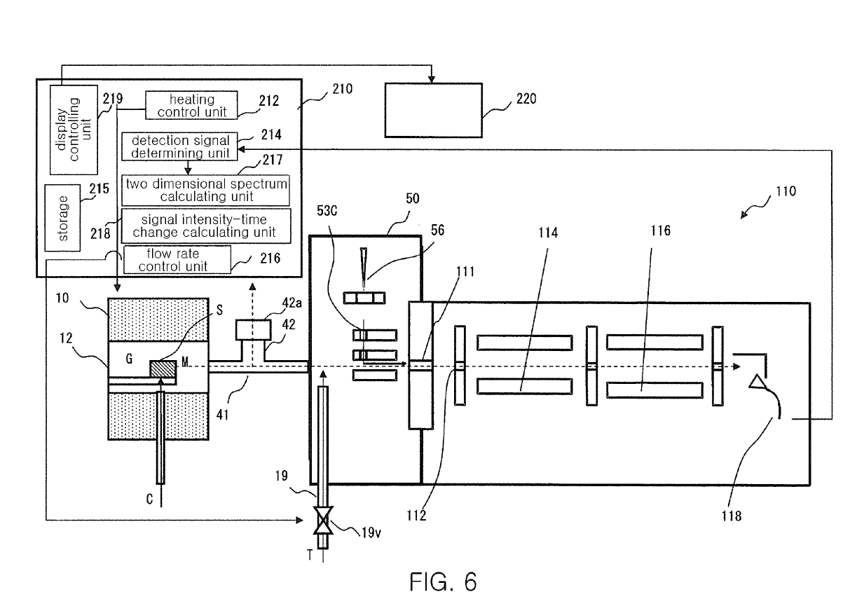

FIG. 6 is a block diagram showing an operation of analyzing a gas component using an evolved gas analysis apparatus 200.

The sample S is heated in the heating chamber 12 of the heating furnace 10, and the gas component G is evolved. Heating condition (temperature rising rate, maximum temperature, etc.) of the heating furnace 10 is controlled by a heating control unit 212 of the computer 210.

The gas component G is mixed with the carrier gas C introduced in the heating chamber 12 to be a mixed gas M, and the mixed gas M is introduced in the splitter 40. A portion of the mixed gas M is discharged from the branching channel 42 to the outside.

The remainder of the mixed gas M is mixed with the inert gas T from the inert gas flow passage 19f to be a total gas (M+T), the total gas is introduced in the ion source 50, and the gas component G is ionized.

A detection signal determining unit 214 of the computer 210 receives a detection signal from a detector 118 (described later) of the mass spectrometer 110.

A flow rate control unit 216 determines whether or not peak intensity of the detection signal received from the detection signal determining unit 214 is within a threshold range. When the peak intensity is out of the threshold range, the flow rate control unit 216 controls the opening ratio of the valve 19v. Therefore, flow rate of the mixed gas M discharged from the splitter 40 to an outside through the branching channel 42 is controlled, and further, flow rate of the mixed gas M introduced from the mixed gas channel 41 into the ion source 50 is controlled, thereby optimizing a detection accuracy of the mass spectrometer 110.

The mass spectrometer 110 includes a first minute hole 111 through which the gas component G ionized at the ion source 50 is introduced; a second minute hole 112 through which the gas component G flows, after flowing through the first minute hole 111; an ion guide 114; a quadrupole mass filter 116; and the detector 118 detecting the gas component G discharged from the quadrupole mass filter 116.

The quadrupole mass filter 116 varies an applied high frequency voltage such that mass is scanned. The quadrupole mass filter generates a quadrupole electric field, and detects ions by moving the ions like a pendulum swinging within the quadrupole electric field. The quadrupole mass filter 116 functions as a mass separator passing only gas component G within a certain mass range such that the detector 118 may identify and quantify the gas component G.

In this example, the inert gas T is caused to flow in the mixed gas channel 41 that is downstream from the branching channel 42, whereby flow resistance is caused to suppress the flow rate of the mixed gas M introduced into the mass spectrometer 110 and the flow rate of the mixed gas M discharged from the branching channel 42 is adjusted. Specifically, the larger the flow rate of the inert gas T, the larger the flow rate of the mixed gas M discharged from the branching channel 42.

Accordingly, when a large amount of a gas component is evolved so that the gas concentration becomes too high, the flow rate of the mixed gas discharged from the branching channel to the outside is increased, whereby it is possible to prevent the measurement from being inaccurate due to overscaled detection signal caused by exceeding the detection range of the detection means.

Next, with reference to FIG. 6 to FIG. 9, spectrum display that is characteristics of the present invention will be described.

The computer 210 of FIG. 6 corresponds to the “spectrum data processing apparatus” of the claims.

First, in this embodiment, a case of measuring the mass spectrum in the scan mode is taken as an example. In the scan mode, a detection signal determining unit 214 acquires a mass spectrum (signal intensity for each mass-to-charge ratio (m/z)) for each point of time. The acquired data is three dimensional mass spectrometry data having time, signal intensities, and mass-to-charge ratio (m/z), and is stored in a storage 215 such as a hard disk.

The mass spectrometry data and the mass-to-charge ratio correspond to “three dimensional spectrum data” and “parameter” of the claims, respectively.

Next, a two dimensional spectrum calculating unit 217 of the computer 210 reads the mass spectrometry data of the storage 215, compiles the signal intensities for each point of time, and calculates a two dimensional spectrum (i.e., mass spectrum) of the signal intensity and the mass-to-charge ratio.

In addition, a signal intensity-time change calculating unit 218 of the computer 210 reads the mass spectrometry data of the storage 215 and calculates a change in signal intensity over time TC for each mass-to-charge ratio.

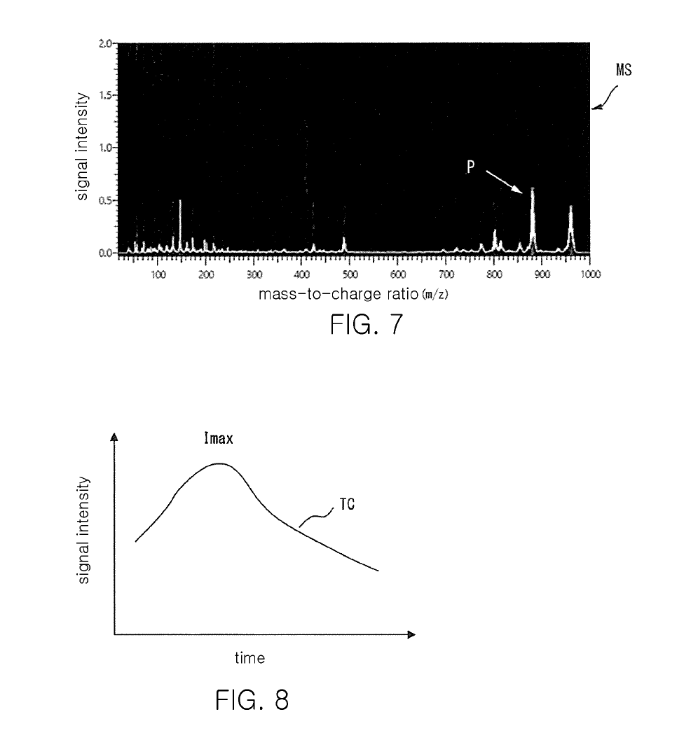

FIG. 7 is a diagram showing an example of a mass spectrum MS calculated by the two dimensional spectrum calculating unit 217. In addition, FIG. 8 is a schematic diagram showing the change in signal intensity over time TC calculated by the signal intensity-time change calculating unit 218, with respect to a mass-to-charge ratio corresponding to a peak P in FIG. 7.

In FIG. 8, the change in signal intensity over time TC shows a behavior in which the intensity increases up to the maximum value Imax and then decreases over time. The signal intensity-time change calculating unit 218 calculates a change in signal intensity over time TC for each mass-charge ratio of each peak of the mass spectrum MS.

Next, a display controlling unit 219 of the computer 210 displays the mass spectrum MS and the change in signal intensity over time TC in a superimposed manner on the display 220.

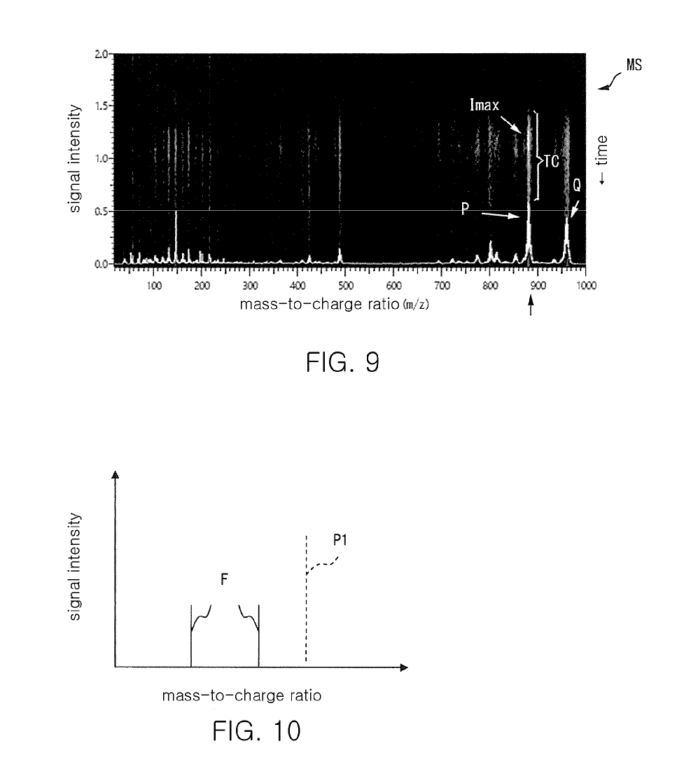

That is, as shown in FIG. 9, the change in signal intensity over time TC is displayed on the position of the mass-to-charge ratio (about 880 (m/z)) of a peak P along the vertical axis over time, by being matched a peak P of the mass spectrum MS. Herein, the change in signal intensity over time TC transits from time 0 of the upper side of the vertical axis in FIG. 9 to downward in FIG. 9 over time.

As shown in FIG. 9, it will be appreciated that the change in signal intensity over time TC is displayed using light and shading, and the maximum value Imax of the intensity described above is displayed as a light portion (white portion).

It is needless to say that the change in signal intensity over time TC is similarly displayed in a superimposed manner with respect to other peaks Q of the mass spectrum MS. In addition, “display in a superimposed manner” is preferably to cause the change in signal intensity over time TC to be displayed on the mass spectrum MS not to be overlaid with the peaks of the mass spectrum MS.

Further, when compiling the signal intensity and calculating the mass spectrum for each point of time, all the data (for example, all the data for each point of time in the scan mode) are complied in the entire time from the start to the end of the measurement. Alternatively, the data may be thinned out and compiled at a preset time interval.

As described above, according to the present embodiment, since the change in signal intensity over time is two-dimensionally displayed in a superimposed manner, in such a way that the mass-to-charge ratio of the mass spectrum is consistent, a relationship between time, signal intensities, and mass-to-charge ratio of the three dimensional mass spectrometry data may be easily understood visually in detail in two dimensions.

For example, even though it is assumed that two peaks F are caused due to fragmentation of the component P1 in a normal mass spectrum of FIG. 10, only the analysis of FIG. 10 does not show that the peak F is a fragmentation peak due to fragmentation of the component P1. Further, the peak P1 sometimes may not actually appear in the mass spectrum.

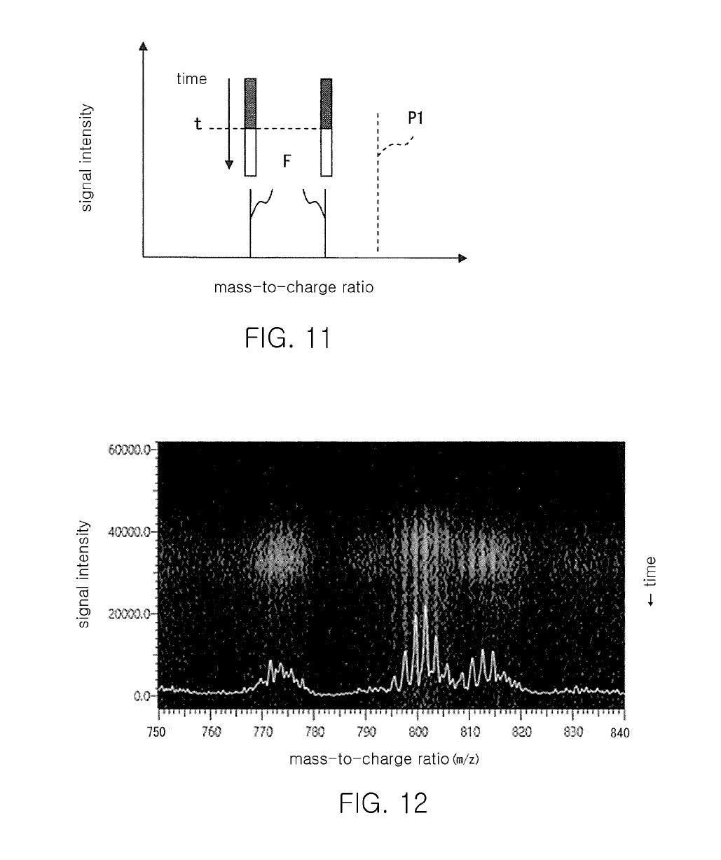

Thus, as shown in FIG. 11, the change in signal intensity over time is displayed in a superimposed manner, in such a way that the change in signal intensity over time matches the mass-to-charge ratio of each peak F, and when the change over time is analyzed, each peak F appears almost simultaneously at time t (bright portion) from dark portion (intensity 0), and it will be appreciated that it is caused due to dissipation. Therefore, it proves that each peak F is caused due to the fragmentation of the component P1. Accordingly, the present invention is more effective when the object substance of the mass spectrum is a polymer that is likely to generate fragmentation ions.

As shown in FIG. 12, when enlarging a part (about 750-840 (m/z)) of the horizontal axis (mass-to-charge ratio) of the mass spectrum MS in FIG. 9, an image on change in signal intensity over time may also be automatically enlarged at the same magnification. This is also true for reduction.

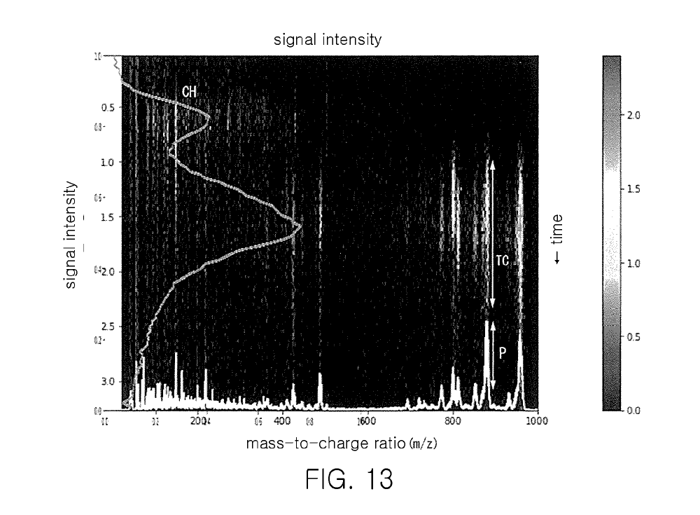

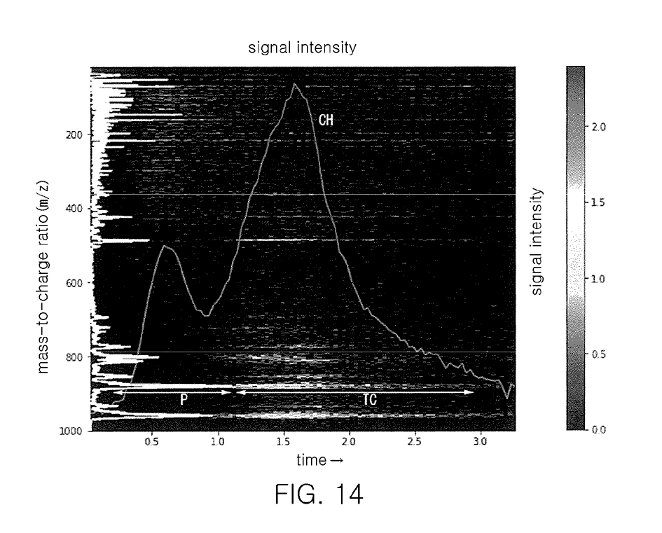

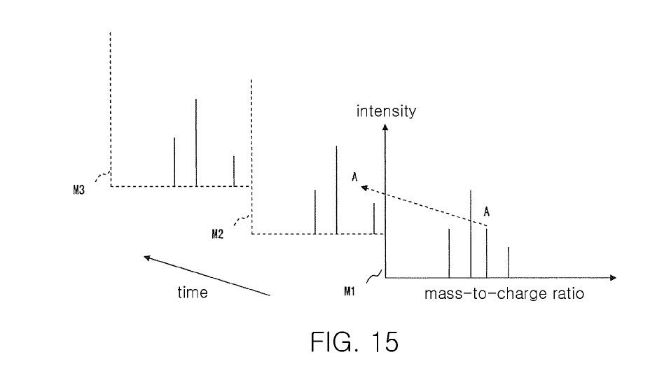

As shown in FIGS. 13 and 14, in addition to the mass spectrum MS and the change in signal intensity over time TC in FIG. 9, a chromatogram CH indicating a relationship between time and signal intensity may be further displayed in a superimposed manner.

In addition, FIG. 13 is obtained by further displaying the chromatogram CH in a superimposed manner along a vertical axis (time axis) with respect to FIG. 9, and an upper horizontal axis represents the signal intensity of the chromatogram CH.

On the other hand, FIG. 14 is obtained by reversing the horizontal axis (mass-to-charge ratio) and the vertical axis (time axis) in FIG. 9, and further displaying a chromatogram CH in a superimposed manner along the horizontal axis (time axis) after reversion, in which the right vertical axis represents the signal intensity of the chromatogram CH after reversion. FIG. 13 clearly shows the mass spectrum and FIG. 14 clearly shows the chromatogram.

In FIG. 14, the time starts from the left side of the horizontal axis, and the change in signal intensity over time TC is similarly displayed in such a way that a left side of the horizontal axis is 0 by inverting the graph of FIG. 13.

Even though the chromatogram CH is a total ion chromatogram in FIG. 13 and FIG. 14, when the operator designates a specific peak P of the mass spectrum, for example, the change in signal intensity over time TC may be Chromatogram CH.

The processing in FIGS. 13 and 14 may be performed as follows.

First, the signal intensity-time change calculating unit 218 of the computer 210 reads the mass spectrometry data of the storage 215 and obtains a chromatogram (total ion chromatogram) CH. In the case of the chromatogram CH of the specific peak P, the change in signal intensity over time TC at the peak P of the mass-to-charge ratio is calculated.

Next, the display controlling unit 219 of the computer 210 displays the change in signal intensity over time TC and the mass spectrum MS in a superimposed manner on the display 220 as described above, and displays the chromatogram CH in a superimposed manner, in such a way that the chromatogram CH is displayed to match the time axis of the change in signal intensity over time TC.

The display controlling unit 219 may determine the position at which the chromatogram CH is displayed on the display unit 220 as a default, but a chart of the peak P or the change in signal intensity over time TC may be possibly superimposed with the chromatogram CH. Accordingly, for example, the operator moves the chromatogram CH to a predetermined position by designation (click, etc.) to allow the display controlling unit 219 to read out the movement information thereof. As such, the chromatogram CH may be displayed at a position in which it is not be superimposed with the peak T or the change in signal intensity over time TC.

The present invention is not limited to the above-described embodiment, but includes various variations and equivalents included in the spirit and scope of the present invention.

The three dimensional spectral data is not limited to the data of the mass spectrometry.

The parameter is not limited to the mass-to-charge ratio, but may be a parameter according to three dimensional spectral data.

The method of displaying the change in signal intensity over time TC is not limited to the use of light and shading. For example, the change in signal intensity over time TC may be displayed in multiple colors by assigning the color according to the signal intensity display (such as color mapping), or as a change in brightness by assigning a brightness according to a signal intensity.

The signal intensity, a change in color, light and shading, or a change in brightness do not need to be proportional, and nonlinear processing such as logarithmic conversion may be performed to emphasize a weak signal intensity.

The method of introducing the sample in the case of mass spectrometry is not limited to the method of evolving the gas component by thermally decomposing the sample in the heating furnace described above, but may be, for example, GC/MS or LC/MS of solvent extraction type that introduces solvent containing a gas component, and generating gas component while volatilizing the solvent.

The ion source 50 is not limited to the type of APCI.

What is claimed is:

1. A spectral data processing apparatus in which a particular spectrum is displayed on a display on a basis of three dimensional spectral data having time, signal intensities, and a prescribed parameter, the apparatus comprising:
a two dimensional spectrum calculating unit compiling the signal intensities for each point of the time and calculating a two dimensional spectrum of the signal intensities and the prescribed parameter, on a basis of the spectral data;
a signal intensity-time change calculating unit calculating a change in the signal intensity over time for each value of the prescribed parameter, on a basis of the spectral data; and
a display controlling unit displaying the two dimensional spectrum on the display, and displaying the change in the signal intensity over time in a superimposed manner on the display using multicolor, light and shading, or a change in brightness, in such a way that the change in the signal intensity over time is displayed to match the prescribed parameter of the two dimensional spectrum and the time changes along an axis of the signal intensities of the two dimensional spectrum.

2. The apparatus according to claim 1, wherein the spectral data is mass spectrometry data, the parameter is a mass-to-charge ratio, and the two dimensional spectrum is a mass spectrum.

3. The apparatus according to claim 2, wherein the spectral data is mass spectrometry data of an organic compound.

4. The apparatus according to claim 3, wherein the spectral data includes fragmentation ions generated as the organic compound is ionized.

5. The apparatus according to claim 1, wherein the display controlling unit is configured to display the two dimensional spectrum and the signal intensities on the display in a superimposed manner, and display a chromatogram representing a relationship between time and signal intensity on the display in a superimposed manner.

6. The apparatus according to claim 2, wherein the display controlling unit is configured to display the two dimensional spectrum and the signal intensities on the display in a superimposed manner, and display a chromatogram representing a relationship between time and signal intensity on the display in a superimposed manner.

7. The apparatus according to claim 3, wherein the display controlling unit is configured to display the two dimensional spectrum and the signal intensities on the display in a superimposed manner, and display a chromatogram representing a relationship between time and signal intensity on the display in a superimposed manner.

8. The apparatus according to claim 4, wherein the display controlling unit is configured to display the two dimensional spectrum and the signal intensities on the display in a superimposed manner, and display a chromatogram representing a relationship between time and signal intensity on the display in a superimposed manner.

9. A spectral data processing method in which a particular spectrum is displayed on a display on a basis of three dimensional spectral data having time, signal intensities, and a prescribed parameter, the method comprising:
a two dimensional spectrum calculating step compiling the signal intensities for each point of the time and calculating a two dimensional spectrum of the signal intensities and the prescribed parameter, on a basis of the spectral data;
a signal intensity-time change calculating step calculating a change in the signal intensity over time for each value of the prescribed parameter, on a basis of the spectral data; and
a display controlling step displaying the two dimensional spectrum on the display, and displaying the change in the signal intensity over time in a superimposed manner on the display using multicolor, light and shading, or a change in brightness, in such a way that the change in the signal intensity over time is displayed to match the prescribed parameter of the two dimensional spectrum and the time changes along an axis of the signal intensities of the two dimensional spectrum.
